(19) United States
(12) Patent Application Publication
(10) Pub. No.: US 2022/0326174 A1
(43) Pub. Date: Oct. 13, 2022

(54) ELECTROCHEMICAL OXYGEN SENSOR

(71) Applicant: Maxell, Ltd., Otokuni-gun (JP)

(72) Inventors: Mitsutoshi Watanabe, Otokuni-gun (JP); Naohisa Kitazawa, Otokuni-gun (JP); Yoshiharu Iwanami, Otokuni-gun (JP)

(73) Assignee: Maxell, Ltd., Otokuni-gun (JP)

(21) Appl. No.: 17/715,262

(22) Filed: Apr. 7, 2022

(30) Foreign Application Priority Data
Apr. 9, 2021 (JP) 2021-066667
Jul. 1, 2021 (JP) 2021-109977

(51) Int. Cl. G01N 27/404; G01N 27/406; G01N 27/409; G01N 27/407; G01N 27/40

(52) U.S. Cl. CPC G01N 27/404; G01N 27/4065; G01N 27/409; G01N 27/4073; G01N 27/4075; G01N 27/40

(57) ABSTRACT

The first electrochemical oxygen sensor includes: a positive/negative electrode; and an electrolyte solution, the electrochemical oxygen sensor further including: a separation membrane for limiting an amount of oxygen supplied to the positive electrode, and a resistance element for connecting the positive electrode and the negative electrode. In one embodiment, a value of current flowing through the resistance element is 7 μA or more in an atmosphere of 50% relative humidity at 25° C. and 1 atm, and a resistance value of the resistance element is set at 1050 Ω or less. In another embodiment, a value of current flowing through the resistance element is 4 μA or more in an atmosphere of 50% relative humidity at 25° C. and 1 atm, and a resistance value of the resistance element is set so that the output voltage between both ends of the resistance element falls within a range from 4 to 9.5 mV.

### BACKGROUND OF THE INVENTION

### 1. Field of the Invention

The present application relates to electrochemical oxygen sensors that can maintain a high measurement accuracy for a long period of time.

### Description of Related Art

In light of advantages that electrochemical oxygen sensors are inexpensive, convenient and operable at room temperature, they have been used widely in various fields, such as for monitoring the deuce of oxygen deficiency in holds of ships and in manholes and for detecting the oxygen concentration in medical equipment such as anesthesia apparatuses and respirators.

An example of such an electrochemical oxygen sensor known is a galvanic cell type oxygen sensor containing an aqueous electrolyte solution and a base metal, such as Pb, Zn or Sn, or an alloy thereof in a negative electrode (e.g., JP 2006-194708 A, JP 2016-006412 A, JP 2018-109549 A). Typically, the galvanic cell type oxygen sensor determines an oxygen concentration by converting the output voltage between both ends of a resistor (e.g., fixed resistor temperature compensation thermistor) that is connected between the positive electrode and the negative electrode, into the oxygen concentration.

The galvanic cell type oxygen sensor establishes a proportional relationship between the oxygen concentration and a value of current flowing through the resistor to generate an output voltage corresponding to .the oxygen concentration, thereby accurately measuring a change of the oxygen concentration in the initial stage of the measurement. However, it has been reported (JP S62-135761 A) that after a long-term use, the slope of a straight line indicating the relationship between the oxygen concentration and the output voltage fluctuates due to the deterioration with time, thereby deviating the oxygen concentration determined by converting the output voltage of the oxygen sensor from the actual oxygen concentration to decrease the measurement accuracy of the oxygen sensor. This problem becomes more pronounced as the oxygen concentration increases. It. is necessary to solve the problem above to provide a galvanic cell type oxygen sensor that can measure a high concentration of oxygen while maintaining a high measurement accuracy for a long period of time.

The galvanic cell type oxygen sensor disclosed in JP S62-135761 A can absorb fluctuation of the output voltage by changing a value of the fixed resistor connected between the positive electrode and the negative electrode in response to the fluctuation of the ambient temperature. Regarding the deterioration with time, JP S62-135761 A teaches that the oxygen concentration in the air can be accurately detected by referring to a ratio between a first measured output voltage value and a subsequent measured output voltage value in each measurement, based on the finding that a ratio of an output voltage V₀ of an initial product, in an atmospheric oxygen concentration of 20.6 (%) and an output voltage V₁ before deterioration with time in an oxygen concentration of 18.0 (%) (hazardous) is the same as a ratio of an output voltage V₀′ of a degraded product in the second or subsequent. measurement in the atmospheric oxygen concentration of 20.6 (%) and an output voltage V₁′ in the oxygen concentration of 18.0 (%) (hazardous).

However, the technique described in JP S62-135761 A is not intended for suppressing a change in the output voltage of the oxygen sensor with time. Further study is necessary to provide an oxygen sensor that can measure a wide range of the oxygen concentration while maintaining a high measurement accuracy for a long period of time.

### SUMMARY OF THE INVENTION

A first electrochemical oxygen sensor of the present application includes: a positive electrode; a negative electrode; and an electrolyte solution, wherein the electrochemical oxygen sensor further includes: a separation membrane for limiting an amount. of oxygen supplied to the positive electrode; and a resistance element for connecting the positive electrode and the negative electrode. A value of current flowing through the resistance element is 7 μA or more in an atmosphere of 50% relative humidity at 25° C. and 1 atm, and a resistance value of the resistance element is set at 1050 Ω or less.

A second electrochemical oxygen sensor of the present application includes: a positive electrode; a negative electrode; and an electrolyte solution, wherein the electrochemical oxygen sensor further includes: a separation membrane for limiting an amount of oxygen supplied to the positive electrode; and a resistance element fox connecting the positive electrode and the negative electrode. A value of current flowing through the resistance element is 4 μA or more in an atmosphere of 50% relative humidity at 25° C. and 1 atm, and a resistance value of the resistance element is set so that the output voltage between both ends of the resistance element falls within a range from 4 to 9.5 mV.

The present application provides a galvanic cell type oxygen sensor that can measure a wide range of the oxygen concentration while maintaining a high measurement accuracy for a long period of time.

### BRIEF DESCRIPTION OF THE DRAWINGS

FIG. 1 is a cross-sectional view schematically illustrating a galvanic cell type oxygen sensor as an exemplary electrochemical oxygen sensor of the present application.

FIG. 2 is a graph illustrating a change in the retention rate of the output voltage in the accelerated life testing of a first oxygen sensor.

FIG. 3 is a graph illustrating a change in the retention rate of the output voltage in the accelerated life testing of a second oxygen sensor.

### DETAILED DESCRIPTION OF THE INVENTION

A first electrochemical oxygen sensor of the present application includes: a positive electrode; a negative electrode; and an electrolyte solution, Wherein the electrochemical oxygen sensor further includes: a separation membrane for limiting an amount, of oxygen supplied to the positive electrode; and a resistance element fir connecting the positive electrode and the negative electrode. A value of current flowing through the resistance element is 7 μA, or more, and more preferably 10 μA or more in an atmosphere of 50% relative humidity at 25° C. and 1 atm, and a resistance value of the resistance element is set at 1050Ω or less, and more preferably 600Ω or less.

A second electrochemical oxygen sensor of the present application includes; a positive electrode; a negative electrode; and an electrolyte solution, wherein the electrochemical oxygen sensor further includes; a separation membrane for limiting an amount of oxygen supplied to the positive electrode; and a resistance element, for connecting the positive electrode and the negative electrode. A value of current flowing through the resistance element is 4 μA or more in an atmosphere of 50% relative humidity at 25° C. and 1 atm. and a resistance value of the resistance element is set so that the output voltage between both ends of the resistance element falls within a range from 4 to 9.5 mV.

Generally, in order to improve a response speed of the electrochemical oxygen sensor by increasing a current flow to a certain extent, the thickness of a separation membrane (which is described later) is reduced to increase an oxygen permeation amount per unit time. This can improve the response speed, but an increased oxygen permeation amount could accelerate a reaction speed of the positive electrode and accordingly accelerates an elution speed of the negative electrode, thereby shortening the service life dale oxygen sensor. On the other hand, if thickening the separation membrane, an oxygen permeation amount could be reduced, thereby lowering the response speed while prolonging the service life.

The electrochemical oxygen sensor of the first aspect of the present application has an improved response speed by increasing a current flow to a certain extent while preventing the loss of the service life due to the increased current flow by controlling the resistance value of a built-in resistor to a predetermined value or less. The electrochemical oxygen sensor of the second aspect of the present application has an improved response speed by increasing a current flow to 4 μA or more, and more preferably 6 μA or more while preventing the loss of the service life due to the increased current flow by controlling the resistance value of a built-in resistor so that the output voltage between both ends of the resistance element falls within a range from 4 to 9.5 mV. Thus, the present application provides oxygen sensors that can measure a wide range of the oxygen concentration while maintaining a high measurement accuracy for a long period of time, and thus contributing to the Sustainable Development Goals (SDGs), Goal 9 “Th7DUSTRY INNOVATION AND INFRABTRUCTURE” and Goal 12 “RESPONSIBLE CONSUMPTION AND PRODUCTION” established by the United Nations, for example.

Next, the reason why the electrochemical oxygen sensors of the present application can prevent the loss of the service life by controlling the resistance value of a built-in resistor to a predetermine value or less is described with reference to a galvanic cell type oxygen sensor (hereinafter also referred to as “oxygen sensor”, shrilly) as a preferred embodiment of the present application.

On an upper portion of the positive electrode of the oxygen sensor of the present application, a separation membrane is disposed that selectively allows oxygen to pass therethrough and limits the amount of oxygen passing therethrough to match the amount of oxygen with cell reaction. Oxygen having passed through the separation membrane and entered the oxygen sensor is reduced by the catalytic, electrode of the positive electrode and causes the following electrochemical reaction with the negative electrode via the electrolyte solution. The following electrochemical reaction equations show a case when using a negative, electrode composed of Sn or a Sn alloy.

Positive electrode reaction: O₂+4H⁺4e⁻→2H₂O

Negative electrode reaction: Sn+2H₂O→SnO₂+4H⁺+4e⁻

Since the amount of oxygen flowing into the positive electrode is limited by the separation membrane, a saturation current characteristic appears in the current-voltage characteristics of the oxygen sensor. In other words, the oxygen sensor reaches a steady state where rill the oxygen flowing into the positive electrode is consumed through the positive electrode reaction. Such a saturation current is called a limit current, and the magnitude of the limit current is determined by an ambient oxygen concentration. Moreover, the oxygen sensor includes a built-in resistor disposed between the positive electrode and the negative electrode to measure an output voltage according to the limit current. Because of this, a proportional relationship is established between the output voltage of the oxygen sensor in a state where the limit current flows, and the ambient oxygen concentration. Thus, the ambient oxygen concentration can be measured by measuring the output voltage of the oxygen sensor in a state where the limit current flows.

If the resistance value of the built-in resistor disposed in the oxygen sensor is set excessively high, only a current smaller than the limits current flows, and the proportional relationship between the output voltage of the oxygen sensor and. the ambient oxygen concentration collapses, not allowing accurate measurement of the ambient oxygen concentration. Further, the inventors of the present application have found that the current-voltage characteristics of the oxygen sensor can change due to the deterioration of the oxygen sensor with time such that. the range of the resistance value of .the built-in resistor used for establishing the proportional relationship between the output voltage of the oxygen sensor and the ambient oxygen concentration can be narrowed toward a low resistance direction.

To solve the problems above, it is advantageous to set the resistance value of the built-in resistor as small as possible. Therefore,. in the first embodiment, the resistance value of the resistor, i.e., the resistance element, is set at 1050Ω or less, and more preferably 600Ω or less. With the resistance value of this range, the proportional relationship between the output voltage of the oxygen sensor and the ambient oxygen concentration is established while the change in the current-voltage characteristics of the oxygen sensor due to the deterioration with time can be absorbed, thereby realizing an oxygen sensor with a prolonged service life.

On the other hand, if the resistance value of the built-in resistor is set too low, the output voltage of the oxygen sensor becomes too small, and a measurement error in the voltage increases undesirably: Therefore, in the first embodiment, the output voltage of the oxygen sensor is preferably set at 5 mV or more, and preferably the lower limit of the resistance value of the built-in resistor is determined so that the output voltage becomes 5 mV or more. Specifically, the resistance value of the resistance element of the oxygen sensor is preferably set at 200Ω or more.

If the separation membrane is too thin, the current value becomes too large, and the service life is shortened. Therefore, the thickness of the separation membrane is preferably 8 μm or more. Further, if the separation membrane is too thick, the current value becomes small, and the response speed becomes slow. Therefore, the thickness of the separation membrane is preferably, although it depends on the material, 40 μm or less, and more preferably 30 μm or less, far example.

Similarly to solve the problem above, it is advantageous to set the resistance value of the built-in resistor at a predetermined value or less so that the output voltage becomes a predetermined value or less. Therefore, in the second embodiment, the resistance value of the built-in resistor, i.e., the resistance element, is set such that the output voltage between both ends becomes 9.5 mV or less when the oxygen sensor is placed in an atmosphere of 50% relative humidity at 25° C. and 1 atm. The resistance value is preferably set such that the output voltage becomes 8 mV or less, and more preferably 7 mV or less. To achieve this, the resistance value of the resistance element may be set at 2375Ω or less, preferably 1500Ω or less, more preferably 1050Ω or less, and particularly preferably 600Ω or less.

On the other hand, if the resistance value of the built-in resistor is set too low, the output voltage of the oxygen sensor becomes too small, and a measurement error in the voltage increases undesirably. Therefore, in the second embodiment, the resistance value of the resistance element is set such that the output voltage of the oxygen sensor becomes 4 mV or more in the above atmosphere. The resistance value is preferably set at 200Ω or more, and more preferably 350Ω or more, for example.

With the resistance element having a resistance value satisfying the above condition, the proportional relationship between the output voltage of the oxygen sensor and the ambient oxygen concentration is established while the change in the current-voltage characteristics of the oxygen sensor due to the deterioration with time can be absorbed, thereby realizing an oxygen sensor with a prolonged service life.

If the separation membrane is too thin, the current value becomes too large and the service life is shortened. Therefore, the thickness of the separation membrane is preferably 8 μm or more. The thickness of the separation membrane is more preferably adjusted so that the current value becomes 10 μA or less, and particularly preferably becomes 7 μA or less when the oxygen sensor is placed in an atmosphere of 50% relative humidity at 25° C. and 1 atm. For example, the thickness of the separation membrane is more preferably 15 μm or more, and particularly. preferably 30 μm or more. Further, if the separation membrane is too thick, the current value becomes small, and the response speed becomes slow. Therefore, the thickness of the separation membrane is preferably, although it depends on the material, 70 μm or less, and more preferably 60 μm or less, for example.

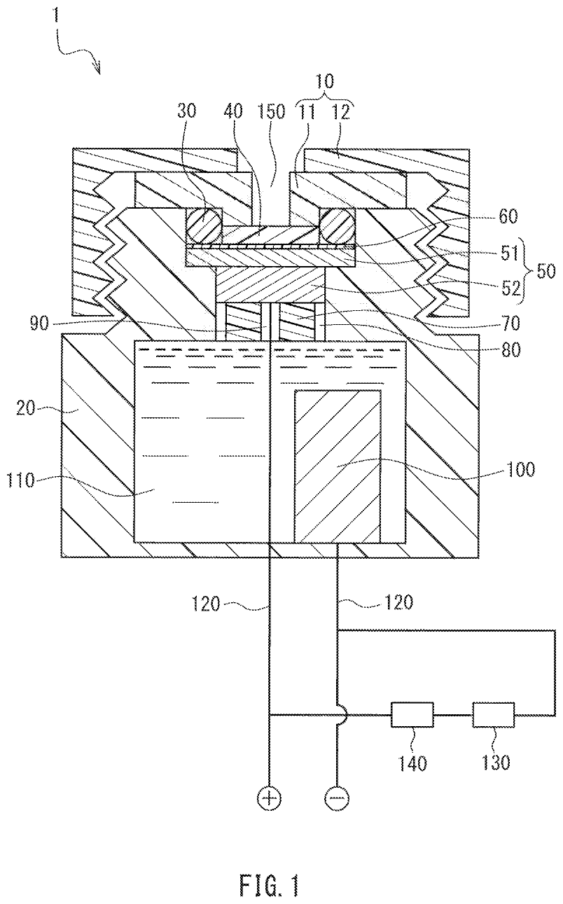

Hereinafter, a galvanic cell type oxygen sensor according to this embodiment. will be described with reference to the drawing. FIG. 1 is a cross-sectional view schematically illustrating the galvanic cell type oxygen sensor according to this embodiment.

An oxygen sensor 1 illustrated in FIG. 1 has a positive electrode 50, a negative electrode 100, and an electrolyte solution 110 in a tubular holder 20 having a bottom. A holder lid 10 having a through-hole 150 for taking oxygen into the oxygen sensor 1 is attached to an upper opening portion of the holder 20 via an O-ring 30, the holder lid 10 being constituted by a first holder lid (inner lid) 11 and a second holder lid (outer lid) 12 for fixing the first holder lid 11.

The negative electrode 100 is arranged in a tank in the holder 20 in a state in which the negative electrode 100 is immersed in the electrolyte solution, the tank storing the electrolyte solution 110. A lead wire 120 is attached to the negative electrode 100, and a fixed resistor (correction resistor) 130 and a temperature compensation thermistor 140 connected in series to the lead wire 120 outside the holder 20 constitutes a resistance element. The resistance element is set to have a total resistance value of, for example, 1050Ω or less in the first embodiment and 1500Ω or less in the second embodiment. The positive electrode 50 is composed by stacking a catalytic electrode 51 and a positive electrode current collector 52, and the lead wire 120 is attached also to the positive electrode current. collector 52. The positive electrode 50 is arranged above the electrolyte solution storage tank via a positive electrode current collector holding portion 70. The positive electrode current collector holding portion 70 is provided with a bore 80 for supplying the electrolyte solution 110 in the electrolyte solution storage tank to the positive electrode 50, and a bore 90 for passing the lead wire 120 attached to the positive electrode current collector 52.

A separation membrane 60 that selectively allows oxygen to pass therethrough and limits the amount of oxygen passing therethrough to match the amount of oxygen with cell reaction is arranged on an upper portion of the positive electrode 50, and oxygen passing through the through-hole 150 in the holder lid 10 is introduced into the positive electrode 50 through the separation membrane 60. A protective film 40 for preventing adhesion of dirt, dust, water, or the like to the separation membrane 60 is arranged on an upper portion of the separation membrane 60 and is fixed by the first holder lid 11.

Specifically, the first holder lid 11 functions as a pressing end plate for pressing the protective film 40, the separation membrane 60, and the positive electrode 50. In the oxygen sensor 1 illustrated in FIG. 1, a threaded portion is formed on an inner circumferential portion of the second holder lid 12 to be screwed on a threaded portion formed on an outer circumferential portion of the holder 20. By screwing the holder lid 10 on the holder 20, the first holder lid 11 is pressed against the holder 20 via the O-ring 30, thereby fixing the protective film 40, the separation membrane 60, and the positive electrode 50 with respect to the holder 20 while maintaining airtightness and liquid tightness.

Next, the operation principle of the galvanic cell type oxygen sensor containing a chelating agent-containing electrolyte solution will be described with reference to FIG. 1.

Oxygen having passed through the separation membrane 60 and entered the oxygen sensor 1 is reduced by the catalytic electrode 51 of the positive electrode 50 and causes the following electrochemical reactions with the negative electrode 100 via the electrolyte solution 110.

Positive electrode reaction: O₂+4H⁺4e⁻→2H₂O

Negative electrode reaction: Sn+2H₂O→SnO₂+4H⁺+4e⁻

Y^{X-}+SnO₂+4H⁺YSn^{4-x}+2H₂O

:Y represents a chelating agent (citric acid)

The negative electrode 100 can be composed of metals such as Cu, Fe, Ag, Ti, Al, Mg, Zn, Ni, Sn, and alloys thereof, and Sn or a Sn alloy is preferred because they are resistant to corrosion in an acidic electrolyte solution and comply with the Restriction of Hazardous Substances Directive, RoHS Directive, adopted by the EU (European Union) (Restriction of the Use of Certain Hazardous Substances in Electrical and Electronic Equipment). The electrochemical reaction equations above represent a case where the negative electrode is composed of Sn or a Sn alloy.

This electrochemical reaction generates a current corresponding to the oxygen concentration between the catalytic electrode 51 and the negative electrode 100. The current generated through the positive electrode reaction at the catalytic electrode 51. is collected by the positive electrode current collector 52 that. is pressed against the catalytic electrode 51, guided to the outside by the lead wire 120, and flows into the negative electrode 100 via the fixed resistor (correction resistor) 130 and the temperature compensation thermistor 140. As a result, the current is converted into a voltage signal, and a voltage as an output of the oxygen sensor can be obtained.

Then, the obtained output voltage is converted into an oxygen concentration by a known method to he detected as an oxygen concentration

Citric acid (Y) as a chelating agent is changed to citrate ions in the electrolyte solution and chelates the constituent metal of the negative electrode to dissolve the chelated metal in the electrolyte solution (hereinafter referred to as a “chelating action”). If the concentration of metal that is derived from the negative electrode (e.g., Sn) and dissolved in the electrolyte solution reaches a saturation concentration, and the resultant metal oxide inactivates the negative electrode, the service life of an oxygen sensor is occasionally shortened.

To cope with this, an attempt has been made to improve the service life of the oxygen sensor by increasing the amount of tin that can be dissolved in the electrolyte solution, i.e., by increasing the molar concentration of the citric acid (Y) in the electrolyte solution, to delay the concentration of tin dissolved in the electrolyte solution from the negative electrode, from reaching the saturation concentration.

Citric acid used in the electrolyte solution of the oxygen sensor according to this embodiment has a plural number of functional groups that coordinate with metal ions to form a complex (complexation) with the metal ions to inactivate the metal ions. Citric acid can be added to an electrolyte solution as citric acid or a salt thereof in a solvent that constitutes the electrolyte solution (citric acid and salt of citric acid are collectively referred to as “citric acids” in the present specification).

In the oxygen sensor according to this embodiment, the electrolyte solution is preferably an aqueous solution at least containing citric acids. Here, the aqueous. solution is preferably adjusted such that it contains an alkali metal, the total content of the citric acids is 2.1 mol/L or more, the content of the alkali metal is 0.1 to 16 times the total content of the citric acids, and the pH is 3.9 to 4.6. The solvent of the electrolyte solution is water. Such an electrolyte solution can increase a molar concentration of the citrate ions to improve the service life of the oxygen sensor.

Chelating agents such as citric acid usually can function a chelating action and a pH buffer capacity (the capacity to keep the pH of a solution nearly constant even if a small amount of acid or base is added). If an acid functioning a chelating action in an aqueous solution or a salt thereof is dissolved in water alone, the pH of the aqueous solution is determined mainly by the type and .the concentration of the chelating agent. Some chelating agents cause the pH of the aqueous solution to into a region where the galvanic corrosion of the negative electrode material can be accelerated, and thus making it difficult to be used in a sensor electrolyte solution.

To adjust the pH of the electrolyte solution in a suitable range while maintaining a high pH buffer capacity, proposals have been made to use a mixed solution containing an acid serving as a chelating agent and a salt. thereof. However, it has been found that citric acid as a chelating agent. does not always improve the service life even if the total content of citric acid and a salt thereof (i.e., citric acids) is increased and the pH of the electrolyte solution is adjusted in a suitable range; further, the presence of a specific amount of an alkali metal (it is presumed that most of the alkali metal is ionized and present as alkali metal ions) in an electrolyte solution containing citric acid is important by dissolving a salt of an alkali metal such as an alkali metal salt of an organic acid, preferably an alkali metal salt of citric acid, in the electrolyte solution, for example.

Although the reasons are unclear, it has been found that the action of the citric acid (including ionized citric acid) as a chelating agent is maximized and the service life of the oxygen sensor is prolonged under the conditions that the total content of the citric acids dissolved in the electrolyte solution is 2.1 mol/L or more while the content of the alkali metal in the electrolyte solution is 0.1 to 1.6 times the total content of the citric acids, and the pH of the electrolyte solution ranges from 3.9 to 4.6.

The electrolyte solution of the above composition can he produced by dissolving citric acids and an alkali metal salt, e.g., citric acid and an alkali metal salt of an organic acid, preferably citric acid and an alkali metal salt of citric acid, in water as a solvent. Examples of the alkali metal salt of citric acid can include tri-alkali metal citrates, di-alkali metal hydrogen citrate, and alkali metal dihydrogen citrate, specifically, lithium salts, sodium salts, potassium salts, rubidium salts, and cesium salts, and preferably trisodium citrate, tripotassium citrate, disodium hydrogen citrate, sodium dihydrogen citrate, dipotassium hydrogen citrate, and potassium dihydrogen citrate.

For example, a mixed solution prepared by dissolving citric acid and tripotassium citrate respectively at a ratio of 1.2 mol/L and 1.0 mol/L in water results in an electrolyte solution in which the total content of the dissolved citric acids is 2.2 mol/L, and the content of the alkali metal (potassium) derived from tripotassium citrate is 1.0×3=3.0 mol/L, i.e., the content of the alkali metal is 3.0/2.2=1.36 times the total content of the citric acids, and the pH at 25° C. is 4.23.

The electrolyte solution of the above composition can also be produced using an alkali metal salt of an organic acid other than citric acid. Examples thereof can include alkali metal salts (including acidic salts) of monocarboxylic acids and polycarboxylic acids such as acetic acid, formic acid, oxalic acid, succinic acid, fumaric acid, maleic acid, tartaric acid, glutalic acid, adipic acid, malic acid, malonic acid, aspartic acid, glutamic acid, and ascorbic acid, and preferably, sodium acetate, potassium acetate, sodium hydrogen oxalate, potassium hydrogen oxalate, disodium oxalate, dipotassium oxalate, sodium hydrogen tartrate, potassium hydrogen tartrate, ammonium potassium tartrate, disodium tartrate, and dipotassium tartrate.. The polycarboxylic acids also act as chelating agents. Therefore, it is expected that addition of polycarboxylic acid or a salt thereof can delay the concentration of tin in the electrolyte solution from reaching the saturation concentration, thus improving the service life of the oxygen sensor.

For example, a mixed solution prepared by dissolving citric acid and potassium acetate respectively at a ratio of 2.5 mol/L and 1.0 mol/L in water results in an electrolyte solution in winch the total content. of the dissolved citric acids is 2.5 mol/L and the content of the alkali metal (potassium) derived from potassium acetate is 1.0 mol/L, i.e., the content of the alkali metal is 1.0/2.5=0.4 times the total content of the citric acids.

A pH adjuster may be added to the electrolyte solution to more appropriately adjust the pH of the mixed solution containing citric acid and an alkali metal salt of an organic arid. Examples of the pH adjuster can include organic acids and salts thereof, inorganic acids and salts thereof, ammonia, and hydroxides. If the mixed solution is composed of citric acid and potassium acetate, the pH at 25° C. can be adjusted to 4.32 by adding 3.0 mol/L of ammonia.

Examples of the organic acids serving as a pH adjuster can include monocarboxylic acids and polycarboxylic acids such as acetic acid, formic acid, oxalic acid, succinic acid, fumaric acid, maleic acid, tartaric acid, glutaric acid, adipic acid, malic acid, malonic acid, aspartic acid and glutamic acid, and ascorbic acid. Examples of the salts of organic acids can include ammonium salts (including acidic salts) of the above organic acids such as ammonium acetate, diammonium tartrate, and ammonium hydrogen tartrate, and salts of citric acid other than alkali metal salts such as diammonium hydrogen citrate and triammonium citrate. In the case of adding the salt of citric acid, the content thereof is added to the total content of the citric acids.

Examples of the inorganic acids serving as a pH adjuster can include hydrochloric acid, sulfuric acid, nitric acid, phosphoric acid, and carbonic acid. Examples of the salts of inorganic acids can include alkali metal salts and ammonium salts (including acidic salts) of the inorganic acids such as ammonium chloride, sodium hydrogen sulfate, potassium hydrogen sulfate, ammonium sulfate, trisiodium phosphate, tripotassium phosphate, disodium hydrogen phosphate, dipotassium hydrogen phosphate, sodium carbonate, potassium carbonate, sodium hydrogen carbonate, potassium hydrogen carbonate, ammonium carbonate, and ammonium hydrogen carbonate. In the case of adding the alkali metal salt of inorganic acid, the content of the alkali metal in the compound is added to the “content of the alkali metal in the electrolyte solution”.

Since ammonia is volatile, the total content of ammonia in the electrolyte solution derived from ammonia water or ammonium salt is preferably within a certain amount or less, considering the change in the composition of the electrolyte solution due to volatilization. The mole ratio of the total content. of ammonia to the total content of the citric acids in the electrolyte solution is preferably Li or less, and more preferably 0.5 or less. The electrolyte solution does not necessarily contain ammonia.

Examples of the hydroxides serving as a pH adjuster can include hydroxides of alkali metals such as sodium hydroxide and potassium hydroxide. In the case of adding the hydroxide of alkali metal, the content of the alkali metal in the compound is added to the “content of the alkali metal in the electrolyte solution”.

The electrolyte solution to be used in this embodiment can he produced by appropriately selecting types of the citric acids and the alkali metal salt and the amount ratio, while adding a pH adjuster if necessary.

The electrolyte solution to be used in this embodiment is adjusted such that. the content of the alkali metal is 0.1 to 1.6 times the total content of the citric acids, and the pH of the electrolyte solution ranges from 3.9 to 4.6. Under the above conditions, as the total content of the citric acids increases, the chelating action of the electrolyte solution can be maintained for a longer period of time. Therefore, to prolong the service life of the oxygen sensor, the total content of the citric acids in the electrolyte solution is preferably 2.4 mol/L or more, and more preferably 2.7 mol/L or more.

Although the reasons are unclear, when the total content of the citric acids and the pH are the same, the chelating action of the electrolyte solution can be maintained for a longer period of time as the content of citric acid in the electrolyte solution increases. Therefore, the content of citric acid in the electrolyte solution is preferably 1.1 mol/L or more, more preferably 1.7 mol/L or more, and particularly preferably 2.0 mol/L or more.

Similarly although the reasons are unclear, when the content of the alkali metal in the electrolyte solution is less than 0.1 times the total content of the citric acids or exceeds 1.6 times the total content of the citric acids, the service life cannot be extended further than a certain length of time. From the viewpoint of increasing the ionic conductivity of the electrolyte solution, the content of the alkali metal in the electrolyte solution is preferably 0.45 times or more the total content of the citric acids. When the content of the alkali metal in the electrolyte solution is less than 0.1 times the total content of the citric acids, it could be difficult to increase the ionic conductivity of the electrolyte solution in the above pH range, which sometimes renders the operation of the oxygen sensor unstable.

The oxygen sensor according to this embodiment is preferably configured such that the volume of the electrolyte solution to the mass of tin, which is a reactant of the negative electrode, is at a predetermined value or more to take advantage of the characteristics of the electrolyte solution. Specifically, the amount of the electrolyte solution is preferably adjusted to satisfy x/y of 0.3 (ml/g) or more, where x represents the volume (ml) of the electrolyte solution in the oxygen sensor, and y represents the content (g) of the tin in the negative electrode. When x/y is less than 0.3 (ml/g), the pH of the electrolyte solution could change quickly during the operation of the oxygen sensor, and the characteristics of the electrolyte solution cannot be fully exhibited, which sometimes results in an insufficient effect of improving the service life of the oxygen sensor.

To reduce the pH change of the electrolyte solution during the operation of the oxygen sensor, the x/y value is preferably 0.7 (ml/g) or more, and more preferably 1 (ml/g) or more. On the other hand, to minimize the volume of the oxygen sensor by reducing the storage volume of the electrolyte solution, the x/y value is preferably 10 (ml/g) or less, more preferably 6.5 (ml/g) or less, and particularly preferably 3 (ml/g) or less.

Although Sn or a Sn alloy is used as the negative electrode of the oxygen sensor according to this embodiment, a Sn alloy is preferred to inhibit a reaction with the electrolyte solution to prevent generation of hydrogen. Examples of the Sn alloy can include Sn—Ag alloys, Sn—Cu alloys, Sn—Ag—Cu alloys, and Sn—Sb alloys, and alloys containing metal elements such as Al, Bi, Fe, Mg, Na, Zn, Ca, Ge, In, Ni, and Co may be used.

Although Sn or a Sn alloy may contain a certain amount of impurities, it is desirable that the Pb content is less than 1000 ppm to comply with the RoHS Directive.

Specifically, preferable examples of the Sn alloy can include general lead-free solder materials (Sn-3.0Ag-0.5Cu, Sn-3.5Ag, Sn-3.5Ag-0.75Cu, Sn-3.8Ag-0.7Cu, Sn-3.9Ag-0.6Cu, Sn-4.0Ag-0.5Cu, Sn-1.0Ag-0.5Cu, Sn-1.0Ag-0.7Cu, Sn-0.3Ag-0.7Cu, Sn-0.75Cu, Sn-0.7Cu—Ni—P—Ge, Sn-1.6Cu—Ni—P—GeSn-1.0Ag-0.7Cu—Bi—In, Sn-0.3Ag-0.7Cu-0.5Bi—Ni, Sn-3.0Ag-3.0Bi-3.0In, Sn-3.9Ag-0.6Cu-3.0Sb, Sn-3.5Ag-0.5Bi-8.0In, Sn-5.0Sb, Sn-10Sb, Sn-0.5Ag-6.0Cu, Sn-5.0Cu-0.15Ni, Sn-0.5Ag-4.0Cu, Sn-2.3Ag—Ni—Co, Sn-2Ag—Cu—Ni, Sn-3Ag-3Bi-0.8Cu—Ni, Sn-3.0Ag-0.5Cu—Ni, Sn-0.3Ag-20Cu—Ni, Sn-0.3Ag-0.7Cu—Ni, Sn-58Bi, Sn-57Bi-1.0Ag and the like), and Sn—Sb alloys.

The positive electrode of the oxygen sensor according to this embodiment may be constituted, for example, by a catalytic electrode and a positive electrode current collector as illustrated in FIG. 1. The constituent material of the catalytic electrode is not particularly limited as long as a current is generated through electrochemical oxygen reduction on the positive electrode, and redox-active catalysts such as gold (Au), silver (Ag), platinum (Pt), and titanium (Ti) are suitably used.

The above-described separation membrane for control of the entry of oxygen is disposed on an outer surface of the positive electrode of the oxygen sensor so as not to allow an excess amount of oxygen to reach the catalytic electrode. Preferably, the separation membrane selectively allows oxygen to pass therethrough while limiting the amount of oxygen gas passing therethrough. The material of the separation membrane is not particularly limited, and a fluorocarbon resin such as polytetrafluoroethylene or a tetrafluoroethylene-hexafluoropropylene copolymer, a polyolefin such as polyethylene, or the like is typically used. Examples of the separation membrane can include porous membranes, non-porous membranes, and membranes called capillary-type in which capillary tubes are formed.

The thickness of the separation membrane is preferably 8 to 40 μm as described above.

To protect the separation membrane, a protective film constituted by a porous resin film is preferably disposed on the separation membrane. The material and the thickness of the protective film are not particularly limited as long as it has a function of preventing adhesion of dirt, dust, water, or the like to the separation membrane while allowing air (including oxygen) to pass therethrough. Typically, a fluorocarbon resin such as polytetrafluoroethylene is used.

The holder 20, which is an outer cover body of the oxygen sensor 1 illustrated in FIG. 1, can be composed of ABS resin, for example. The holder lid 10 (the first holder lid 11 and the second holder lid 12) disposed on the opening portion of the holder 20 can be composed of ABS resin, polypropylene, polycarbonate, fluorocarbon resin, or the like, for example. The positive electrode current collector holding portion 70 for holding the positive electrode 50 in the holder 20 can be composed of ABS resin, for example.

The O-ring 30 interposed between the holder 20 and the holder lid 10 (the first holder lid 11) is pressed and deformed by screwing the second holder lid 12 on the holder 20, thereby maintaining airtightness and liquid tightness of the oxygen sensor 1. The material of the O-ring is not particularly limited, and nitrile rubber, silicone rubber, ethylene-propylene ribber, a fluorocarbon resin, or the like is typically used.

Although the foregoing exemplifies the galvanic cell type oxygen sensor according to this embodiment, the oxygen sensor of the present application is not limited to the embodiment described above, and various changes and modifications can be made within the scope of the technical idea of the invention. With regard to the oxygen sensor illustrated in FIG. 1 as well, various changes and modifications in design can be made as long as functions as the, oxygen sensor and the above oxygen supply pathways are provided.

Hereinafter; the, oxygen sensor of the present application will be described with reference to the examples. However, the following examples do not limit the oxygen sensor of the present application.

A first oxygen sensor of the present application will be described.

### EXAMPLE 1-1

<Preparation of Electrolyte Solution>

An electrolyte solution was prepared by dissolving citric acid, tripotassium citrate, and ammonia, in water. The molar concentration was 2.5 mol/L for citric acid, 0.5 mol/L for tripotassium citrate, and 3.0 mol/L for ammonia, in the electrolyte solution. The total content of the citric acids dissolved in the electrolyte solution was 3.0 mol/L, the content of the alkali metal (potassium) dissolved therein was 1.5 mol/L, which was 0.5 times the total content of the citric acids, and the pH of the electrolyte solution was 4.30 at 25° C. The mole ratio of the total content of ammonia to the total content of the citric acids in the electrolyte solution was 1.

<Assembly of Oxygen Sensor>

A galvanic cell type oxygen sensor having the configuration illustrated in FIG. 1 was assembled using 4.3 ml of the above electrolyte solution. The holder lid 10 (the first holder lid 11 and the second holder lid 12), the holder 20, and the positive, electrode current collector holding portion 70 were firmed using ABS resin. The protective film 40 used was a porous polytetrafluoroethylene sheet, and the separation membrane 60 used was a 12-μm-thick tetrafluoroethylene-hexafluoropropylene copolymer membrane.

The catalytic electrode 51 of the positive electrode 50 was composed of gold, each of the positive electrode current collector 52 and the lead wire 120 used was made of titanium, and the positive electrode current collector 52 and the lead wire 120 were welded to each other. The negative electrode 100 was composed of 3.7 g of a Sn—Sb alloy (the Sb content was 5 mass %, and the mass of Sn was 3.52 g), and the lead wire 120 was also attached to the negative electrode.

A resistance element (the combined resistance at 25° C., 539Ω) was constituted by series connection of the temperature compensation thermistor 140 having a resistance value of 500Ω and the fixed resistor (correction resistor) 130 having a resistance value of 39Ω at 25° C. The resistance element was connected to the lead wires 120, 120 of the positive electrode and the negative electrode.

In the oxygen sensor 1, the first holder lid 11, the O-ring 30, the protective film 40 constituted by the polytetrafluoroethylene sheet, the separation membrane 130 constituted by the tetrafluoroethylene-hexafluoropropylene copolymer membrane the catalytic electrode 51, and the positive electrode current collector 52 were pressed against each other by screwing the second holder lid 12 on the holder 20, and thus maintaining a favorable contact state. The first holder lid 11 functioned as a presser end plate, and the O-ring 30 secured the airtightness and the liquid tightness. The ratio between the amount (4.3 ml) of the electrolyte solution stored and the mass (3.52 g) of Sn contained in the negative electrode was 1.22 (ml/g).

### EXAMPLE 1-2

A galvanic cell type oxygen sensor of Example 1-2 was assembled in the same manner as in Example 1-1 except for the use of a 25-μm-thick tetrafluoroethylene-hexafluoropropylene copolymer membrane as a separation membrane.

### EXAMPLE 1-3

A galvanic cell type oxygen sensor of Example 1-3 was assembled in the same manner as in Example 1-2 except for the use of a resistance element (the combined resistance at 25° C. 973Ω) constituted by series connection of a temperature compensation thermistor having a resistance value of 900Ω and a fixed resistor (correction resistor) having a resistance value of 73Ω at 25° C.

### COMPARATIVE EXAMPLE 1-1

A galvanic cell type oxygen sensor of Comparative Example 1-1 was assembled in the same manner as in Example 1-1 except for using: a resistance element (the combined resistance at 25° C. 1082Ω) constituted by series connection of a temperature compensation thermistor having a resistance value of 1 kΩ; and a fixed resistor (correction resistor) having a resistance value of 82Ω at 25° C.

### COMPARATIVE EXAMPLE 1-2

A galvanic cell type oxygen sensor of Comparative Example 1-2 was assembled in the same manner as in Example 1-1 except for using: a 50-μm-thick tetrafluoroethylene-hexafluoropropylene copolymer membrane as a separation membrane; and a resistance element (the combined resistance at 25° C., 10220Ω) constituted by series connection of a temperature compensation thermistor having a resistance value of 10 kΩ and a fixed resistor (correction resistor) having a resistance value of 220Ω at 25° C.

The oxygen sensors of the examples and the comparative examples were left to stand in an atmosphere of 50% relative humidity at 25° C. and 1 atm, and the voltages between both ends of the resistance elements were measured to determine the current flowing through each resistance element. Table 1 shows the results.

TABLE 1

| | Current value (μA) |
|---|---|
| Example 1-1 | 20.3 |
| Example 1-2 | 11.9 |
| Example 1-3 | 11.8 |
| Comparative Example 1-1 | 21.4 |
| Comparative Example 1-2 | 5.0 |

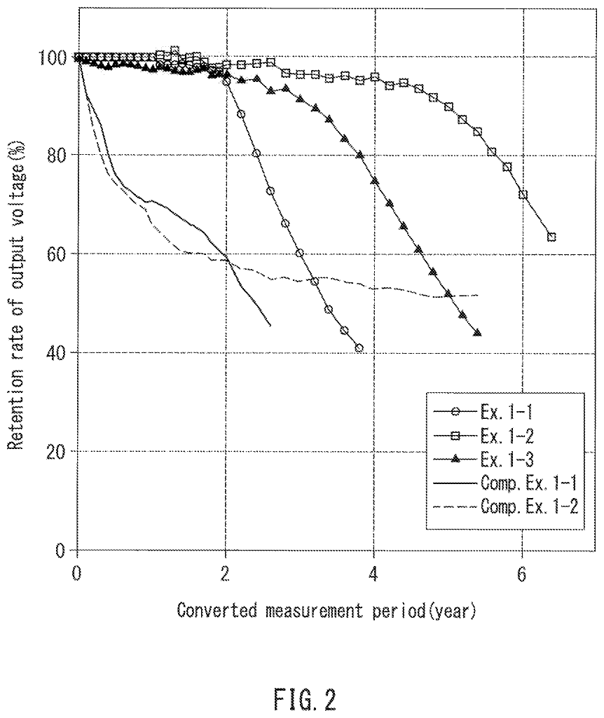

Next, accelerated life testing was performed by passing 100% oxygen gas through each of the oxygen sensors of the examples and the comparative examples in an atmosphere at 40° C. Electrochemical reactions at 40° C. proceed about twice as fast as those at room temperature. Electrochemical reactions when 100% oxygen gas is passed through the oxygen sensor proceed about 5 times as fast as those in the air. Therefore, this accelerated life testing performed at 40° C. with passage of 100% oxygen gas can determine the service lives of the oxygen sensors about 10 times faster than in the case where they are left to stand at room temperature in the air. In this testing., the output voltages of the oxygen sensors were measured, FIG. 2 shows the change (i.e., retention rate) in the output voltage from the initial voltage of 100%. In FIG. 2, the horizontal axis indicates a measurement period converted by multiplying the actual measurement time by 10.

The oxygen sensor that can maintain a retention rate of nearly 100% (e.g., the retention rate of 90% or more) for a longer period of time is judged as an oxygen sensor capable of maintaining a high measurement accuracy fir a longer period of time. The results in FIG. 2 indicate that the galvanic cell .type oxygen sensors of Examples 1-1 to 1-3 according to the present. application can maintain a high measurement accuracy for a long period of time as compared with the oxygen sensors of Comparative Examples 1-1 and 1-2.

Next, a second oxygen sensor of the present application will be described.

### EXAMPLE 2-1

A galvanic cell type oxygen sensor of Example 2-1 was assembled in the same manner as in Example 1-1 except for the use of a 25-μm-thick tetrafluoroethylene-hexafluoropropylene copolymer membrane as the separation membrane 60.

### EXAMPLE 2-2

A galvanic cell type oxygen sensor of Example 2-2 was assembled in the same mariner as in Example 2-1 except for using: a 50-μm-thick tetrafluoroethylene-hexafluoropropylene copolymer membrane as a separation membrane; and a resistance element (the combined resistance at 25° C., 1082Ω) constituted by series connection of a temperature compensation thermistor having a resistance value of 1 kΩ and a fixed resistor (correction resistor) having a resistance value of 82Ω at 25° C.

### COMPARATIVE EXAMPLE 2-1

A galvanic cell type oxygen sensor of Comparative Example 2-1 was assembled in the same manner as in Example 2-2 except for using a 12-μm-thick tetrafluoroethylene-hexafluoropropylene copolymer membrane as a separation membrane.

### COMPARATIVE EXAMPLE 2-2

A galvanic cell type oxygen sensor of Comparative Example 2-2 was assembled in the same mariner as in Example 2-2 except for using a resistance element (the combined resistance at 25° C. 10220Ω) constituted by series connection of a temperature compensation thermistor having a resistance value of 10 kΩ and a fixed resistor (correction resistor) having a resistance value of 220Ω at 25° C.

### COMPARATIVE EXAMPLE 2-3

A galvanic cell type oxygen sensor of Comparative Example 2-3 was assembled in the same manner as in Comparative Example 2-1 except for using a resistance element (the combined resistance at 25° C., 539Ω) constituted by series connection of a temperature compensation thermistor having a resistance value of 500Ω and a fixed resistor (correction resistor) having a resistance value of 39Ω at 25° C.

### COMPARATIVE EXAMPLE 2-4

A galvanic cell type oxygen sensor of Comparative Example 2-4 was assembled in the same manner as in Example 2-1 except for using a resistance element (the combined resistance at 25° C., 973Ω) constituted by series connection of a temperature compensation thermistor having a resistance value of 900Ω and a fixed resistor (correction resistor) having a resistance value of 73Ω at 25° C.

The oxygen sensor of the examples and the comparative examples were left to stand in an atmosphere of 50% relative humidity at 25° C. and 1 atm, and the voltages between both ends of the resistance elements were measured to determine the current flowing throw each resistance element. Table 2 shows the results.

TABLE 2

| | Current value (μA) | Output voltage (mV) |
|---|---|---|
| Example 2-1 | 11.9 | 6.4 |
| Example 2-2 | 5.2 | 5.6 |
| Comparative Example 2-1 | 21.4 | 23.2 |
| Comparative Example 2-2 | 5.0 | 51.1 |
| Comparative Example 2-3 | 20.3 | 10.9 |
| Comparative Example 2-4 | 11.8 | 11.5 |

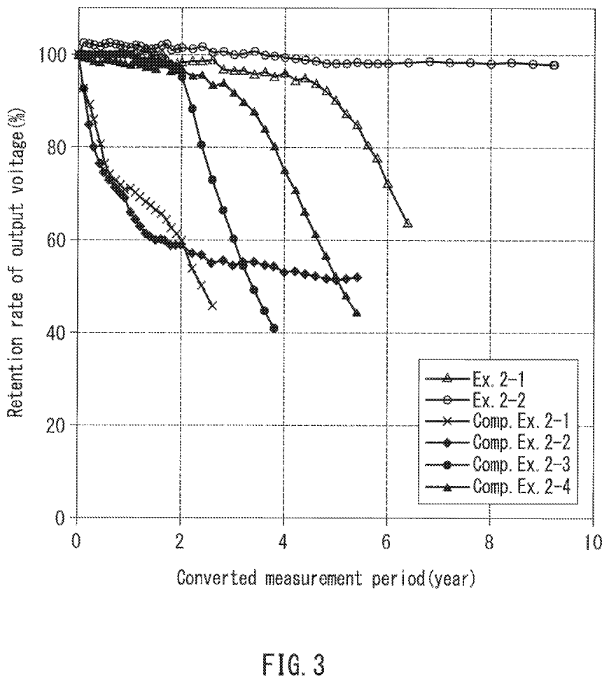

Next, accelerated life testing was performed by passing 100% oxygen gas through each of the oxygen sensors of the examples and the comparative examples in an atmosphere at 40° C. Electrochemical reactions at 40° C. proceed about twice as fast as those at room temperature. Electrochemical reactions when 100% oxygen gas is passed through the oxygen sensor proceed about 5 times as fast as those in the air. Therefore, this accelerated life testing performed at 40° C. with passage of 100% oxygen gas can determine the service lives of the oxygen sensors about 10 times faster than in the case where they are left to stand at room temperature in the air. In this testing, the output voltages of the oxygen sensors were measured. FIG. 3 shows the change (i.e., retention rate) in the output voltage from the initial voltage of 100%. In FIG. 3, the horizontal axis indicates a measurement period converted by multiplying the actual measurement time by 10.

The oxygen sensor that can maintain a retention rate of nearly 100% (e.g., the retention rate of 90% or more) for a longer period of time is judged as an oxygen sensor capable of maintaining a high measurement accuracy for a longer period of time. The results in FIG. 3 indicate that the galvanic cell type oxygen sensors of Examples 2-1 and 2-2 according to the present application can maintain a high measurement accuracy for a long period of time as compared with the oxygen sensors of Comparative Examples 2-1 to 2-4.

Particularly the galvanic cell type oxygen sensor of Example 2-2 in which the thickness of the separation membrane was set to have a current value of 10 μA or less can maintain a high measurement accuracy for a long period of time as compared with the galvanic cell type oxygen sensor of Example 2-1 having a current glue larger than 10 μA. This indicates that decreasing the current value by adjusting the thickness of the separation membrane enables the oxygen sensor of the present application to prolong the period of maintaining a high measurement accuracy.

The present application can be embodied in other farms without departing from the spirit thereof. The embodiments disclosed in the present application are examples, and the present application is not limited to these embodiments. The scope of the present application is indicated by the appended claims rather than by the foregoing description, and all changes that come within the meaning and range of equivalency of the claims are intended to be embraced therein.

1. An electrochemical oxygen sensor comprising:
a positive electrode;
a negative electrode; and
an electrolyte solution,
wherein the electrochemical oxygen sensor further comprises:
a separation membrane for limiting an amount of oxygen supplied to the positive electrode; and
a resistance, element for connecting the positive electrode and the negative electrode, and wherein a value of current flowing through the resistance element is 7 μA or more in an atmosphere of 50% relative humidity at 25° C. and 1 atm, and
wherein a resistance value of the resistance element is set at 1050Ω of less.

2. The electrochemical oxygen sensor according to claim 1, wherein the resistance element comprises a. fixed resistor and a thermistor element.

3. The electrochemical oxygen sensor according to claim 1, wherein the separation membrane has a thickness of 8 μm or more.

4. The electrochemical oxygen sensor according to claim 1, wherein the separation membrane comprises a fluorocarbon resin.

5. The electrochemical oxygen sensor according to claim 1, wherein the electrolyte solution is an aqueous solution comprising a chelating agent.

6. The electrochemical oxygen sensor according to claim 5, wherein the electrolyte solution comprises a citric acid or a salt thereof.

7. The electrochemical oxygen sensor according to claim 5, wherein the electrolyte solution comprises the chelating agent in an amount of 2.0 mol/L or more.

8. The electrochemical oxygen sensor according to claim 1, wherein the electrochemical oxygen sensor satisfies x/y≥0.3 (ml/g), where x represents a volume (ml) of the electrolyte solution, and y represents a content (g) of tin in the negative electrode.

9. The electrochemical oxygen sensor according to claim 1, wherein the negative electrode comprises Sn or a Sn alloy.

10. An electrochemical oxygen sensor comprising:
a positive electrode;
a negative electrode; and
an electrolyte solution,
wherein the electrochemical oxygen sensor further comprises:
a separation membrane for limiting an amount of oxygen supplied to the positive electrode; and
a resistance element for connecting the positive electrode and the negative electrode, and
wherein a value of current flowing through the resistance element is 4 μA or more in an atmosphere of 50% relative humidity at 25° C. and 1 atm, and
a resistance value of the resistance element is set so that the output voltage between both. ends of the resistance element falls within a range from 4 to 9.5 mV

11. The electrochemical oxygen sensor according to claim 10, wherein the resistance element comprises a fixed resistor and a thermistor element.

12. The electrochemical oxygen sensor according to claim 10, wherein the value of current flowing through the resistance element is 10 μA or less.

13. The electrochemical oxygen sensor according to claim 10, wherein the resistance value of the resistance element is 1500Ω or less.

14. The electrochemical oxygen sensor according to claim 10, wherein the separation membrane has a thickness of 8 μm or more.

15. The electrochemical oxygen sensor according to claim 10, wherein the separation membrane comprises a fluorocarbon resin.

16. The electrochemical oxygen sensor according to claim 10, wherein the electrolyte:
solution is an aqueous solution comprising a chelating agent.

17. The electrochemical oxygen sensor according to claim 16, wherein the electrolyte solution comprises a citric acid or a salt thereof.

18. The electrochemical oxygen sensor according to claim 16, wherein the electrolyte solution comprises the chelating agent in an amount of 2.0 mol/L or more.

19. The electrochemical oxygen sensor according to claim 10, wherein the electrochemical oxygen sensor satisfies x/y≥0.3 (ml/g), where x represents a volume (ml) of the electrolyte solution, and y represents a content (g) of tin in the negative electrode.

20. The electrochemical oxygen sensor according to claim 10, wherein the negative electrode comprises Sn or a Sn alloy.
